(19) United States
(12) Patent Application Publication
(10) Pub. No.: US 2003/0009340 A1
(43) Pub. Date: Jan. 9, 2003

(54) Synthetic voice sales system and phoneme copyright authentication system

(76) Inventors: Kazunori Hayashi, Fukuoka (JP); Masaru Mase, Fukuoka (JP); Yoichi Korehisa, Fukuoka (JP); Ryoichi Yuge, Fukuoka (JP); Masayuki Inoue, Fukuoka (JP)

Correspondence Address: RATNERPRESTIA, P O BOX 980, VALLEY FORGE, PA, 19482-0980, US

(21) Appl. No.: 10/164,740

(22) Filed: Jun. 7, 2002

(30) Foreign Application Priority Data
Jun. 8, 2001 (JP) 2001-173689
Jun. 8, 2001 (JP) 2001-173690
Jan. 28, 2002 (JP) 2002-018087

(51) Int. Cl. G10L 21/00

(52) U.S. Cl. 704/270

(57) ABSTRACT

A system comprising: a copyright owner registration section for registering a copyright owner of phonemes; a phoneme combination section for combining phonemes using a database constructed of phonemes supplied from a phoneme capture section; a royalty calculation section for calculating the royalty for the copyright of the phonemes according to the information on the amount of phonemes used, for each of copyright owners; and a monetary payment section for providing payment of the royalty to the copyright owner based on the information on the charges. This system protects the copyright of the phonemes the speaker has and allows users to readily purchase products or services utilizing phonemes.

### FIELD OF THE INVENTION

The present invention relates to a synthetic voice sales system and a phoneme copyright authentication system that authenticate the copyright of a phoneme, i.e. the smallest constituent component of a speech sound, and provide customers with products or services utilizing phonemes.

### BACKGROUND OF THE INVENTION

Recent years has seen progress in speech synthesis techniques that convert text data, such as e-mails and data produced by a word processor, into speech sounds. Among these techniques, “natural speech voice waveform signal connecting voice synthesizer” disclosed in Japanese Patent No. 3050832 provides a speech synthesis technique that can provide more natural voice quality than conventional examples.

This invention provides a technique of connecting phonemes actually sampled and extracted from the voice of a speaker and thereby converting them into speech sounds. For example, suppose there is a speech of “Watashi wa Hayashi desu (i.e. I am Hayashi.). The speech information is generated by connecting each of sound groups, such as “wa”, “ta”, “shi”, and “wa”. Because no signal processing is performed at the generation of the speech sounds with this technique, a synthetic voice utilizing the features of the speaker can be obtained.

Therefore, the industry has rising expectations for applications of this technique, such as speech sounds of animation character toys and virtual characters produced by computer graphics or the like. It has been difficult to realize such applications with the conventional speech synthesis techniques.

Under these circumstances, it may be possible that a person other than the speaker can record the speech sound of the speaker via television, radio, or other media, extract necessary phonemes, and connect the extracted phonemes to generate speech information of the speaker without his permission.

However, the above-mentioned conventional technique has the following problems. A voice dictionary or phonemes generated from the voice of a particular person is considered to have the own personality (of the speaker). Thus, when a person other than the speaker uses the phonemes of the speaker without his permission, the speaker suffers disadvantages. Therefore, in the future, when a voice dictionary or phoneme database is constructed from voices of a person, a copyright must be secured on the phonemes that have the own personality of the speaker. In addition, when the phonemes of the speaker are used, the royalty for the copyright of the phonemes must be paid to the copyright owner of the phonemes according the use.

When products or services utilizing phonemes are offered (sold) to users, it is necessary to offer (sell) the products or services after the authentication of the copyrights of the phonemes. However, such a system has not been put into practical use. Before this problem is solved, users cannot readily receive services utilizing phonemes. This situation may hinder the development of various kinds of businesses utilizing phonemes.

### SUMMARY OF THE INVENTION

The present invention provides a synthetic voice sales system comprising:

a phoneme capture section for capturing a phoneme, i.e. the smallest constituent component of a human voice;

a copyright owner registration section for registering a copyright owner of the phoneme;

a phoneme combination section for combining a phoneme supplied from the phoneme capture section and for pronouncing the combined phoneme;

a usage calculation section for calculating the amount of the phoneme used by the phoneme combination section; and

a monetary payment section for providing payment of a usage charge to an account, according to the information on the phoneme usage calculated by the phoneme usage calculation section and the registration in the copyright owner registration section.

### BRIEF DESCRIPTION OF THE DRAWINGS

FIG. 1 is a basic block diagram of a synthetic voice sales system in accordance with the present invention.

FIG. 2 is a flowchart of a phoneme accumulation process in the synthetic voice sales system in accordance with the present invention.

FIG. 3 is a flowchart illustrating a process from a step of selling products or services utilizing phonemes to a step of paying a royalty, in a copyright authentication and synthetic voice sales system in accordance with the present invention.

FIG. 4 is an explanatory view illustrating the synthetic voice sales system in accordance with the present invention in its entirety.

FIG. 5 is a schematic explanatory view of a business utilizing the synthetic voice sales system in accordance with the present invention.

### PREFERRED EMBODIMENT OF THE INVENTION

An exemplary embodiment of the present invention is demonstrated hereinafter with reference to the accompanying drawings.

(Exemplary Embodiment)

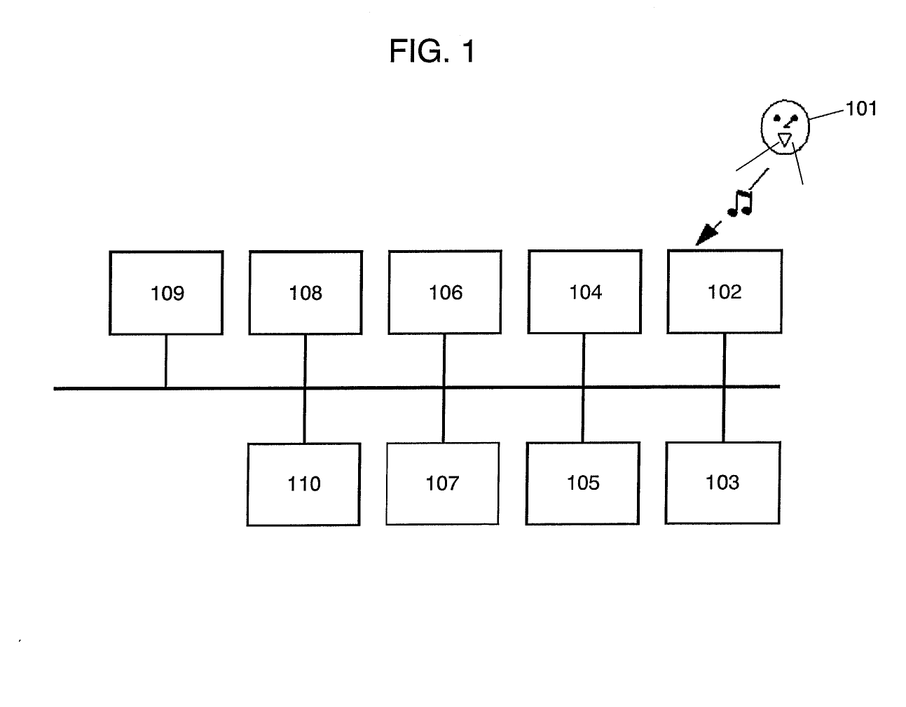

An exemplary embodiment of a synthetic voice sales system of the present invention is specifically described with reference to FIGS. 1 to 5. FIG. 1 is a basic block diagram of a synthetic voice sales system of the present invention. With reference to FIG. 1, a phoneme registrant generates natural voice 101. Phoneme capture section 102 has a microphone for collecting natural voice 101 generated, constructs a database of phonemes extracted from natural voice 101 that has been fed into the microphone, and stores the database. Copyright owner registration section 103 associates the phonemes that are sampled from natural voice 101 captured by phoneme capture section 102 with the information on the copyright owner of the phonemes, and stores the associated data.

Phoneme combination section 104 uses the phoneme database constructed by phoneme capture section 102, analyses speech synthesis subject data (e.g. text data), and pronounces a combination of the most appropriate phonemes. Phoneme usage calculation section 105 calculates the amount of the phonemes used by phoneme combination section 104 in the process of speech synthesis. Royalty calculation section 106 calculates the royalty for the copyright of the phonemes for the copyright owner thereof, according to the result of the information on the amount of the phonemes used in the process of speech synthesis, e.g. the phoneme usage calculated by phoneme usage calculation section 105. Monetary payment section 107 provides payment of the royalty for the copyright to the copyright owner of the phonemes based on the information on the charge supplied from royalty calculation section 106. Salas section 108 supplies products or services utilizing the phonemes to customers. Sales section 108 comprises a means of transmitting the data obtained from phoneme combination section 104 to a client user and a means of collecting the usage charge from the client user. Phoneme database storage 109 stores a database of phoneme data of human voices. Speech synthesis subject data storage 110 accumulates text and other data of novels, comics, and other publications.

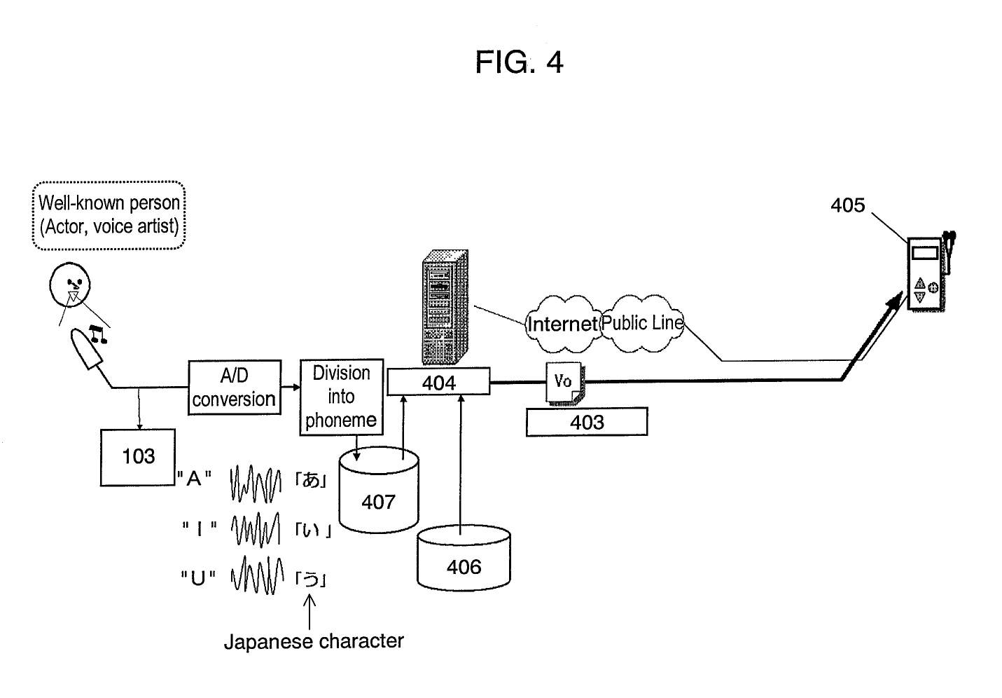

FIG. 4 is an explanatory view illustrating a synthetic voice sales system in accordance with the embodiment of the present invention in its entirety. With reference to FIG. 4, synthetic voice data 403 is delivered from a server. Server 404 on a network, such as the Internet and a leased line, performs speech synthesis, using speech synthesis subject data and a phoneme database of a voice character that have been designated by a user, and delivers synthetic voice data 403 to the user.

Phoneme combination section 104, royalty calculation section 106, monetary payment section 107 for providing payment of a royalty for a copyright, and sales section 108 are incorporated in server 404 on the Internet, for example.

Server 404 also has a database of speech synthesis subject data 406 in which speech synthesis subject data is accumulated, and phoneme database 407 in which phoneme data of voice characters is stored.

Phoneme database 407 is constructed of sampled data of actually existing persons' natural voices. In a case, a phoneme is a sound made of a combination of at least one of a vowel sound, such as Japanese characters “A” and “I”, and a consonant sound, such as Japanese characters “KA” and “KI”. In another case, a phoneme is a single sound, i.e. the smallest unit of successive speech sounds. (For example, “aki” is made of single sounds of “a”, “k”, and “i”). In another case, a phoneme is a word, clause, or sentence. In another case, a phoneme is an onomatopoeia, imitation sound, or mimetic word. In another case, a phoneme is an unprocessed analog signal or digital synthetic voice.

Next, the operations are described. The operations of this system are roughly classified into two parts. One is the operation performed from the step of capturing a natural voice to the step of accumulating phonemes. The other is the operation performed from the step of selling products or services utilizing the phonemes to the step of paying the royalty for the copyright of the phonemes to the copyright owner of the phonemes. First, the phoneme accumulation operation of this system is described.

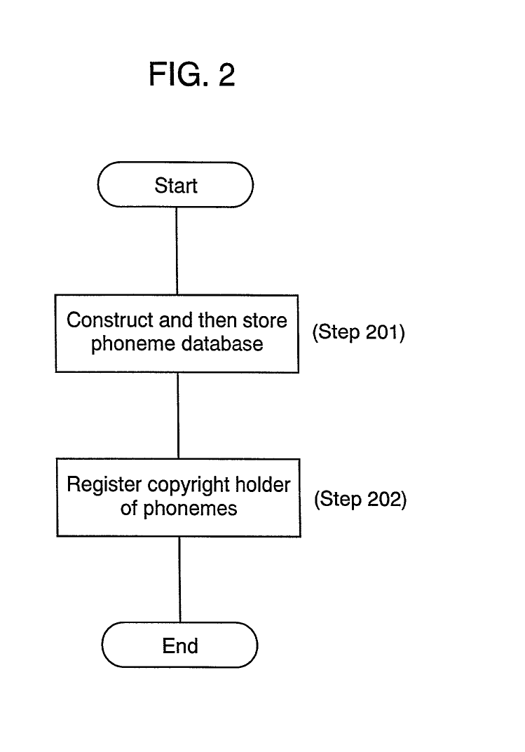

FIG. 2 is a flowchart illustrating a phoneme accumulation process in the synthetic voice sales system of the present invention. When a phoneme registrant speaks, phoneme capture section 102 having a microphone or the like analyses the generated natural voice and labels the information on the sounds or the like for each phoneme. Such information includes the duration, fundamental frequency, and power of the sounds, the name of a data file containing the phoneme, and the start and end positions of the phoneme in the file. Then, phoneme capture section 102 constructs a database in an arbitral format and stores the database (Step 201).

Next, copyright owner registration section 103 registers a copyright owner of the phonemes captured by phoneme capture section 102 (Step 202). At this time, copyright owner registration section 103 associates the phonemes sampled from the speaker with the copyright owner thereof and records the associated data. In most cases, the speaker himself is registered as the copyright owner. However, the copyright owner is not necessarily the speaker himself and the copyright owner of the phonemes can be registered arbitrarily. When the copyright owner is different from the speaker himself, an agent or the like under contract with the speaker is registered.

In a registration procedure, the name of the phoneme copyright owner may be written and the descriptions in the written document may be stored or recorded. For example, when recording the phonemes at a recording studio, a voice artist, actor, or the like writes the name of the copyright owner of the phonemes and the descriptions in the written document are recorded in copyright owner registration section 103 in this system. Alternatively, when the phonemes are recorded using an unmanned terminal, the copyright owner thereof may register the name of the copyright owner as his name, using buttons on the terminal. Of course, any other method can be used on condition that the method associates the phonemes sampled from the speaker with the copyright owner thereof and records the associated data.

As far as phonemes can be captured from the speaker and the copyright owner of the captured phonemes can be registered, the operations of Steps 201 and 202 in the process shown in FIG. 2 can be performed in reverse order. Described hereinabove is the operation of phoneme accumulation.

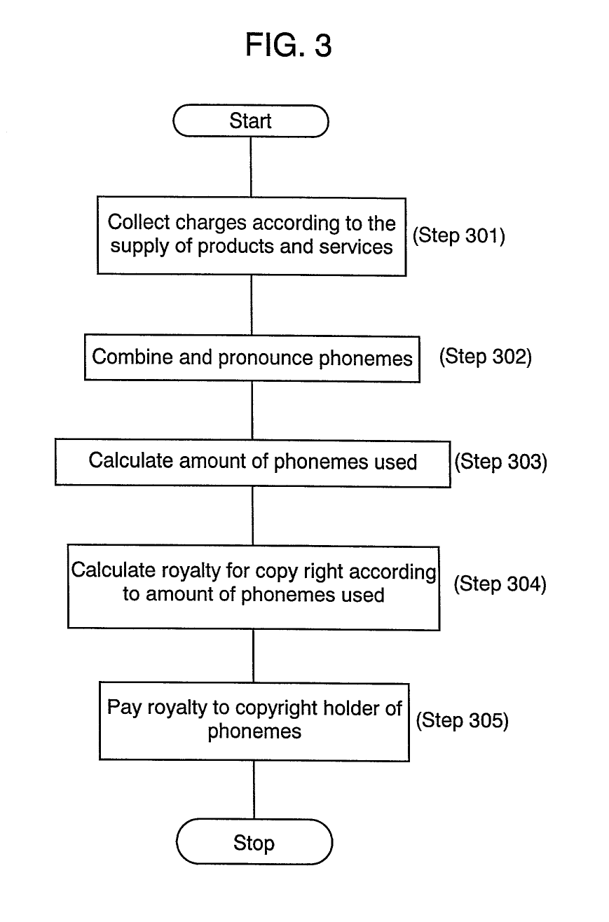

FIG. 3 is a flowchart illustrating a process from the step of selling products or services utilizing phonemes to the step of providing payment of the royalty for the copyright of the phonemes, in a phoneme copyright authentication and synthetic voice sales system of the present invention. At the request of a user, sales section 108 carries out procedures, such as a contract for selling products or services utilizing phonemes, and collects the charges for the products or services from the user (Step 301). A plurality of forms in collecting charges is considered as follows.

The charges may be collected according to the number of voice characters supplied to the user, or the quality of voice characters (i.e. public evaluation). The charges may be collected according to the amount of phoneme data of each character, or the number of data items or the amount of data to undergo speech synthesis using the phonemes. The charges may also be collected according to the number of data items or the amount of data produced by speech synthesis. Of course, the charges can be collected according to combinations of the above-mentioned charge collection factors.

The procedure performed by this sales section 108 is not limited to the above descriptions on condition that the procedure can implement the supply of products or services utilizing phonemes.

When such procedures as a contract with the client user have been completed, phoneme combination section 104 performs speech synthesis, using a phoneme database of a particular character and speech synthesis subject data (data to be read) that have been selected by the client user. In other words, the speech synthesis subject data is analyzed, the most appropriate phonemes are selected from the phoneme database and connected, and the obtained synthetic voice is transmitted to the client user (Step 302). Then, the amount of the phonemes used in the process of speech synthesis is calculated (Step 303).

In this description, calculation is performed on the phoneme usage. Instead, the calculation can be performed on the usage of the speech synthesis subject data to undergo speech synthesis or the usage of the synthetic voice. Of course, the term “usage” includes the meanings of the amount of data and the period of synthesis time.

Next, royalty calculation section 106 calculates the royalty for the copyright of the phonemes, according to the usage and the calculation result of the usage supplied from phoneme usage calculation section 105 (Step 304). Then, monetary payment section 107 provides payment of the royalty to the copyright owner of the phonemes based on this information. In some cases, sales section 108 collects charges based on this royalty information (Step 305).

The order of operations from Steps 301 to 305 in the process is not fixed. As far as sales of products or services utilizing phonemes, pronunciation of combined phonemes, and payment of the royalty to the copyright owner of the phonemes can be implemented, these steps can be performed in any order.

Next, description is given with reference to FIG. 4. For example, a client user communicates with server 404 on the Internet via terminal 405, selects the type of the phoneme database and data to be read, thereby carrying out the procedures for requesting services. When the procedures have been completed, server 404 performs speech synthesis of the speech synthesis subject data using the phoneme database of the selected voice character, and delivers the synthetic voice data 403 to the client user using a communication means. The client user can listen to the synthetic voice of the desired voice character by capturing synthetic voice data 403 delivered from server 404 into terminal 405 and reproducing the synthetic voice data.

Server 404 is not necessarily on the Internet. For example, the server can accept a request of a user by telephone, verbal communication, fax or mail. Then, the server can record the generated synthetic voice data on recording media, e.g. an optical disk, magnetic disk, and memory card, and delivers the media to the user by mail or hand. The speech synthesis subject data is not only available as a database in the server. The client user can send subject data to server 404 to request speech synthesis thereof.

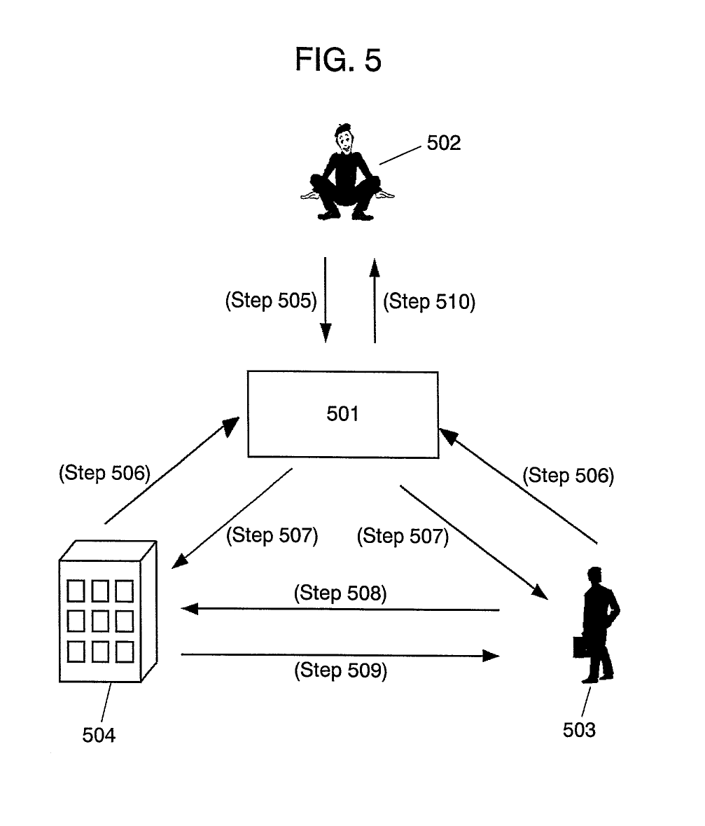

FIG. 5 shows a schematic explanatory view of a business utilizing the synthetic voice sales system of the present invention. Synthetic voice sales system 501 of the present invention sells products or services utilizing phonemes to customers and pays the royalty for the copyright of the phonemes to the copyright owner of the phonemes according to the use thereof. Phoneme provider 502 provides phonemes for the synthetic voice sales system of the present invention. General user 503 purchases products or services utilizing phonemes from the synthetic voice sales system of the present invention. Contents provider 504 who offer services, e.g. speech information, to general users also receives services utilizing phonemes from the synthetic voice sales system of the present invention. The contents providers include enterprises, such administrative organs as a city government, such education facilities as a school, religious bodies, and information media bodies related to television, radio, press and publication, and film production bodies.

When phoneme provider 502 provides phonemes for this system, the system registers the copyright owner of the provided phonemes (Step 505).

Next, a contents provider and a general user make requests of purchasing products or services utilizing phonemes to the system via a network or by means of telephone, fax, mail, verbal communication, or combinations thereof (Step 506).

Examples of such products or services include: a toy capable of converse with the user using phonemes; a virtual character existing on a network and produced by such means as computer graphics; a voice synthesis service providing data that has been converted from speech synthesis subject data to a speech of a character's voice the user desires. Such speech synthesis subject data includes: sentences produced by the user, e.g. a life history of the user; dramas; regional dialects; received messages in a cell phone or the like; novels and news already prepared; and speeches or the like in animated cartoons and films. Of course, any other products or services utilizing phonemes can be dealt with.

Next, the synthetic voice sales system sells the products or services at the service request of the user (Step 507). In some products, phoneme combination section 104 in the system of the present invention is incorporated in the unit supplied to the user. This case applies to a product of stand-alone type that performs speech synthesis inside of the unit. Such types of products include a robot toy. The robot toy incorporates in the unit a speech recognition capability and an artificial intelligence capability for building response sentences, and other capabilities as well as the phoneme combination section, and also has a phoneme database in the internal or external memory of the unit. Thus it can converse with the user using substantially a natural voice.

For the speech synthesis services, the system performs speech synthesis using the phoneme database of a voice character requested by the user and the designated speech synthesis subject data. The synthetic voice data is delivered to the user via a network, or recorded on recording media, e.g. an optical disk, magnetic disk, and semiconductor memory, and delivered to the user by mail or hand. Then, sales section 108 collects the charges from the user.

For the speech synthesis services, a general user captures delivered synthetic voice data 403 into terminal 405 having a synthetic voice data input section and a speech sound output section and reproduces the data. Thus the synthetic voice of the desired voice character is reproduced. The synthetic voice data input sections include: a network interface (e.g. a modem) and a data input section for storing media (e.g. an optical disk, magnetic disk, and semiconductor memory). The sound output sections include a speaker, headphone, and earphone.

The contents provider records delivered synthetic voice data 403 on recording media to prepare for service requests of general users. The general user requests such services as news and administrative information of a character's voice from the contents provider via a network or by the means of telephone, fax, mail, verbal communication, or combinations thereof (Step 508). The contents provider delivers the requested service to the general user via a network, or records the data on recording media, e.g. an optical disk, magnetic disk, and semiconductor memory, and delivers the media to the general user by mail or hand (Step 509). Then, the general user can capture the delivered synthetic voice data into the above-mentioned section to listen to the synthetic voice sound.

Phoneme usage calculation section 105 inside of the system calculates the amount of phonemes used by phoneme combination section 104. According to the phoneme usage, royalty calculation section 106 calculates the royalty for the copyright, and pays the royalty for the copyright of the phonemes used to the copyright owner thereof (Step 510). Alternatively, when a managing company or the like under contract with the speaker is registered as the account for receiving the royalty, the royalty is paid to the managing company or the like.

The system of the present invention allows a copyright owner of phonemes to receive the royalty for the copyright according to the use of the phonemes and a user of services utilizing phonemes to readily receive the services. This system can help businesses utilizing phonemes develop greatly.

What is claimed is:

1. A synthetic voice sales system comprising:
(a) a phoneme capture section for capturing a phoneme, i.e. a smallest constituent component of a human voice;
(b) a copyright owner registration section for registering a copyright owner of the phoneme;
(c) a phoneme combination section for combining the phoneme supplied from said phoneme capture section and for pronouncing the combined phoneme;
(d) a phoneme usage calculation section for calculating an amount of the phoneme used by said phoneme combination section;
(e) a monetary payment section for providing payment of a usage charge to an account, according to information on the phoneme usage calculated by said phoneme usage calculation section and registration in said copyright owner registration section.

2. The synthetic voice sales system as set forth in claim 1, wherein said copyright owner registration section registers an account for receiving a royalty for a copyright of the phoneme when the phoneme is used.

3. A synthetic voice sales system comprising:
(a) a phoneme, the phoneme being a smallest constituent component of a voice and having a personality, and a phoneme capture section for capturing the phoneme;
(b) a copyright owner registration section for registering a copyright owner of the phoneme;
(c) a phoneme combination section for combining the phoneme using a database constructed of the phoneme supplied from said phoneme capture section and for pronouncing the combined phoneme;
(d) a phoneme usage calculation section for calculating an amount of the phoneme used by said phoneme combination section;
(e) a royalty calculation section for calculating a royalty for a copyright of the phoneme according to the phoneme usage calculated by said phoneme usage calculation section for each copyright owner of the phoneme;
(f) a monetary payment section for providing payment of the royalty for the copyright to the copyright owner of the phoneme based on information from said royalty calculation section; and
(g) a sales section for supplying one of a product and a service utilizing the phoneme to a user.

4. The synthetic voice sales system as set forth in claim 3, wherein said sales section sends information obtained from said phoneme combination section to the user and collects a charge from the user.

5. A synthetic voice sales system comprising:
(a) a phoneme database, wherein said database is constructed of data of a phoneme, the phoneme being a smallest constituent component of a voice;
(b) a phoneme combination section for reading out and connecting an appropriate phoneme from said phoneme database and for generating synthetic voice data for each of analyzed speech synthesis subject data;
(c) a server having a delivery section for delivering to a user the synthetic voice data generated by said phoneme combination section;
(d) a registration section for registering an account for receiving a royalty for a copyright of the phoneme when the phoneme is used;
(e) a usage calculation section for calculating an amount of the phoneme used by said phoneme combination section; and
(f) a monetary payment section for providing payment of a usage charge to the account registered in said registration section, according to information on the phoneme usage calculated by said usage calculation section.

6. The synthetic voice sales system as set forth in any one of claims 1, 3, and 5, wherein the phoneme is a sound made of a combination of at least one of a vowel sound and a consonant sound.

7. The synthetic voice sales system as set forth in any one of claims 1, 3, and 5, wherein the phoneme is a word.

8. The synthetic voice sales system as set forth in any one of claims 1, 3, and 5, wherein the phoneme is one of a clause and a sentence.

9. The synthetic voice sales system as set forth in any one of claims 1, 3, and 5, wherein the phoneme is one of an onomatopoeia and a mimetic word.

10. The synthetic voice sales system as set forth in claim 1, wherein the phoneme is a digital synthetic sound.

11. A phoneme copyright authentication system comprising:
(a) a phoneme capture section for capturing a phoneme, i.e. a smallest constituent component of a voice;
(b) a copyright owner registration section for registering a copyright owner of the phoneme captured by said phoneme capture section;
(c) a phoneme combination section for combining the phoneme, using a database constructed of the phoneme supplied from said phoneme capture section and for pronouncing the combined phoneme; and
(d) a royalty calculation section for calculating a royalty for a copyright of the phoneme according to information on an amount of the phoneme used in a phoneme combination process by said phoneme combination section for each copyright owner of the phoneme.

12. The phoneme copyright authentication system as set forth in claim 11, further comprising:
a phoneme usage calculation section for calculating the amount of the phoneme used by said phoneme combination section; and
a monetary payment section for providing payment of a usage charge to an account registered in said copyright owner registration section, according to information on the phoneme usage calculated by said phoneme usage calculation section.
